(19) United States
(12) Patent Application Publication
(10) Pub. No.: US 2011/0032477 A1
(43) Pub. Date: Feb. 10, 2011

(54) Variable Prism Eyeglasses and Method of Making Same

(76) Inventors: Roger Vahram Ohanesian, Laguna Beach, CA (US); John Vincent Cronin, Newport Beach, CA (US)

Correspondence Address: George T. Parsons, 2736 Aegean Drive, San Diego, CA, 92139-3211, US

(21) Appl. No.: 12/462,764

(22) Filed: Aug. 10, 2009

(51) Int. Cl. G02C 7/14; G02C 7/08

(52) U.S. Cl. 351/175

(57) ABSTRACT

The present invention is an eyeglass device that has manually variable prisms to correct Strabismus; that is, double vision. Variable prism glasses allow the doctor or patient to adjust the prism power to the minimum required at a particular time and no more. They also allow adjustment of the prisms so that they work the weak eye muscles. In time the weak muscles may become strong enough so that prism glasses are no longer needed. The present invention has numerous embodiments. The medical profession can treat Strabismus, also called Convergence Insufficiency (CI), both actively and passively. The active treatment provides the doctor with a varied range of therapeutic options. The doctor has the ability to change the treatment program as often as necessary without the interruption of ordering new glasses because the present invention changes to meet the needs of the patient. When the invention is used in a passive fashion, it allows the patient to manually adjust the prism strength without removing the eyeglasses.

### BACKGROUND OF THE INVENTION

1. Field of the Invention

The present invention relates generally to eyeglass devices, and, more specifically, to a lens system that uses variable prisms to correct Strabismus, that is, double vision.

2. Description of the Related Art

The invention described herein is directed at providing a solution to the problem of Strabismus, commonly referred to as double vision. Specific conditions within Strabismus are Hyperphoria/tropia, Exophoria/trophia, and Esophoria/tropia. Another term for this condition is Convergence Insufficiency (CI). This condition can be described as eye misalignment caused by extra ocular muscle imbalance, i.e., both eyes are unable to focus on one visual target at the same time. Phoria is a tendency for the eye to become out of alignment when one eye is obstructed, Tropia is when the eye is definitely out of alignment even when both eyes are unobstructed.

Any muscle system is subject to fatigue when it is used continuously without periods of rest. Although muscles of the eye do not work against forces outside the eye, they do exert forces against each other, and they become “fatigued” from periods of continuous ocular activity. As eye muscles are not unique, they too show evidence of fatigue when visual tasks require added effort and concentration. And, they too recover their optimal levels of function after rest.

The external muscles of the eyes must work together to keep both eyes centered on the point of interest. Balance between the muscles is somewhat imperfect in most people, and there is some tendency for the eyes not to converge correctly. If the medial rectus muscle is becomes fatigued, the lateral rectus can overpower it causing the eye to rotate outwards, towards the temple. The result is normally called double vision, but the medical term is Strabismus. specifically in this case, exotropia.

In the prior art, the medical community has dealt with this problem through the use of fixed or nonadjustable prism glasses. Prisms placed in these glasses address off center vision. While these lenses correct the misaligned eye muscles, they do not address the issue of muscle fatigue. Short-term use of prism glasses associated with slightly more demanding visual situations, such as reading or driving can cause the weak muscle to become temporarily weaker. While some patients do not require the full time use of prism glasses, they may develop the need when the eye fatigues. Prescribing a prism lens to someone who has only an intermittent problem may exacerbate the disorder. So, over long periods of time the weak muscle will continue to atrophy and a stronger lens may be required causing a continued deterioration of vision.

The novel present invention of variable prism glasses seeks to address these long known problems experienced by the medical community and patients. No relevant prior art has been found after extensive searching through databases and trade literature.

Therefore, it is the overall object of the present invention to provide a novel eyeglass prism to eliminate the above mentioned disadvantages. One specific objective of the present invention is to provide variable prisms to be installed in eyeglasses to relieve patients of Strabismus. Another major object is to provide a way for a physician to therapeutically assist a patient by strengthening weak eye muscles. It is still another specific object to provide the patient with a rotatable pin to adjust the diopters of one or both prisms in the eyeglasses to optimize visual acuity when suffering Strabismus. Another objective of the present invention is to provide a simple variable prism design to allow relatively inexpensive manufacture and reasonable retail cost to patients. And yet another objective is to provide multiple embodiments of the variable prism. To date, to the knowledge of the Applicants, no such variable prism has been invented to treat Strabismus. The Applicants think the present invention overcomes a long-standing, and even ignored opportunity, that has resulted in millions of people suffering from long term vision acuity deterioration. Within children, this new technique has the added benefit of strengthening muscles by adjusting prisms thereby forcing weak muscles to work harder and possibly eliminating the disorder.

### SUMMARY OF THE INVENTION

Strabismus affects millions of Americans. While exact numbers are not known, it is estimated that as many as 24 million people are afflicted with this condition. The above-mentioned difficulties and problems are overcome by the present invention.

This invention allows the medical profession to not only treat but correct Strabismus, also named Convergence Insufficiency (CI), both actively and passively. The active treatment provides the doctor with a varied range of therapeutic options. The doctor has the ability to change the treatment program as often as necessary without the interruption of ordering new glasses, as the invention changes to meet the needs of the patient. When the invention is used in a passive fashion, it allows the patient to manipulate the prism strength without removing the eyeglasses. Variable prism glasses (VPG) allow the patient to adjust the prism power to the minimum required at a particular time and no more. They also allow him to adjust the prisms so that they strengthen the weak muscle. In time the weak muscle may become strong enough so that prism glasses are no longer needed.

In view of the problems associated with the modern day active and passive treatment of Strabismus, the invention addresses the problems and provides a unique solution, solving most issues through the use of rotating prisms integrated into a standard pair of eyeglasses. More specifically, but in summary, the present invention is comprised of six lenses total, three devoted to each eye. Two of the lenses (one for each eye) are standard prescription corrective lenses that the patient would use to correct vision clarity. These two lenses are fixed in place.

The four lenses that are novel to the invention are prisms. A prism can be defined as an optical grade of transparent plastic or glass with two polished surfaces. The surfaces of the prism are inclined toward each other. As light passes through the prism, it is refracted. The degree, or angle, of refraction is dependent on the material and angle of incline in the prism.

Each set of VPG contains four prisms, two for each eye. Each prism lens can be rotated independently by a physician or patient. When light passes through this set of prism lenses, and the prism lenses are rotated, the degree of refraction changes. In other words, by rotating the prisms, the patient's center of vision changes. This refractive change gives the doctor or patient the ability to realign the visual target with the fovea in each eye. The fovea, or fovea centralis, is a depression toward the center of the retina where the vision is most acute and consists of cone cells which provide the most acute vision.

Normal binocular vision allows for clear independent vision of one visual target in each eye, creating a single clear visual image. In other words, both eyes are looking at the same subject, at the same time. A person afflicted with Strabismus lacks this ability, as each eye focuses on a different visual target. The prism lenses in the present invention rotate to change the visual target, and allow the patient to realign incoming light onto the fovea, producing one visual target, thus creating normal binocular vision.

It is important to note that when the invention is used passively, that is, by the patient, the glasses meets the ever-changing refractive needs of the patient through minor adjustment. When used actively, that is, therapeutically by the doctor, the setting of the glasses can be preselected by the doctor in charge of the patient's therapy. It is the intent of the VPG to reduce the level of refraction through exercising the appropriate ocular muscle, thus eliminating the patient's double vision and need for prism glasses altogether.

There are multiple novel features in the use of variable prisms as have been designed. One of these is the ability of the doctor to therapeutically correct Strabismus in a patient through adjustment of the prisms. Yet another novel feature is that the patient can make minor adjustments using the rotatable pin or pins during the day as needed when eye fatigue occurs. Another novel feature is that with the present invention, Strabismus can be corrected through gradual strengthening of one or more eye muscles. All these novel features mean there are multiple advantages to millions of people affected by double vision. They are able to remove frustration, improve vision, drive and move safely, and potentially eliminate this condition.

These, and other, novel features and advantages of the present invention are set forth more completely in the accompanying drawings and the following description.

### BRIEF DESCRIPTION OF THE DRAWINGS

Details of the invention, and of the preferred embodiments thereof, will be further understood upon reference to the drawings, wherein closely related elements have the same number but different alphabetical suffixes, and further wherein:

FIG. 1 is a perspective view of a preferred embodiment of variable prism eyeglasses of the present invention,

FIG. 2 is a partial perspective section view of a typical two prism embodiment with prescription lens of the present invention,

FIG. 3 is an exploded section view of a typical two prism embodiment with prescription lens of the present invention,

FIG. 4 is a partial view of eyeglass prisms showing multiple light ray traces for numerous lens diopters of multiple embodiments of the present invention,

FIG. 5 is a partial view of a prism holder illustrating degree ranges for active and passive Strabismus therapy of the present invention, and

FIG. 6 is a partial view of numerous positions of rotatable pins used to change the diopters of the prisms to treat Strabismus in the present invention.

### DETAILED DESCRIPTION OF THE PREFERRED EMBODIMENTS

The above-mentioned difficulties and problems are overcome by the present invention. The present invention of variable prisms is intended to be installed in an eyeglass frame. The eyeglasses are typically, and preferably, comprised of a total of six lenses, three devoted to each eye. Two of the lenses, one for each eye, are standard prescription corrective lenses that the patient would use to correct vision clarity. These two lenses are fixed in place. The four lenses that are novel to the invention are prisms.

The purpose of the Variable Prism Glasses (VPG) is to correct Strabismus. As light passes through the VPG it is refracted to match the patient's degree of Strabismus. Because the degree of Strabismus varies throughout the day, the VPG can be adjusted to meet the patient's fluctuating needs. The ability of the invention to change its refractive properties to meet the needs of the patient are described herein.

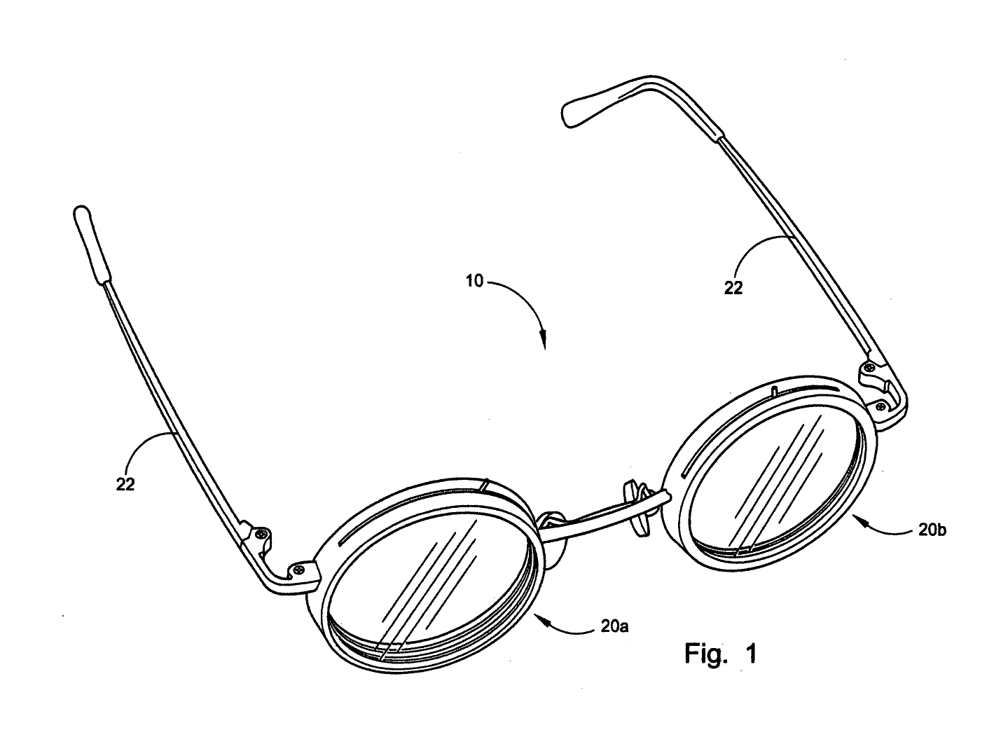

Referring first to FIG. 1, a perspective view of a preferred embodiment is shown of variable prism eyeglasses of the present invention. Typical eyeglasses with variable prisms installed (10) are seen with a right prescription lens and two variable prisms (20a) and a left prescription lens with two variable prisms (20b).

Alternatively, another embodiment of the present invention includes a right and left prescription lens and one variable prism for each eye. Still another embodiment includes a right and left prescription lens with two variable prisms. Yet other embodiments would have one, or alternatively, two variable prisms for both eyes, without any prescription lenses at all. Therefore, many embodiments exist.

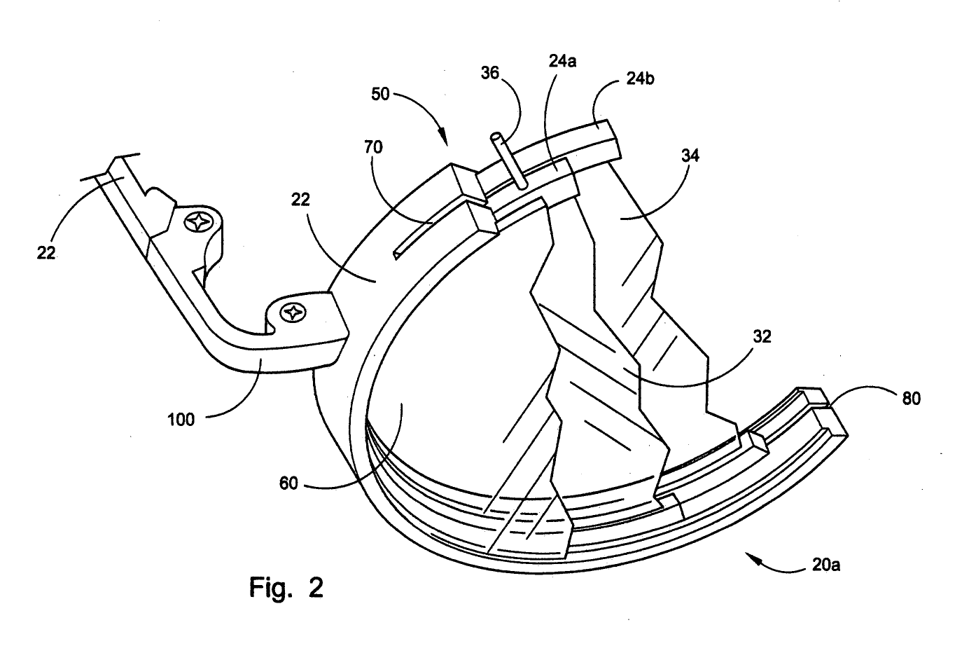

Referring now to FIG. 2, a partial perspective section view of a typical two prism embodiment with prescription lens is shown of the present invention. A right prescription lens with two variable prisms (20a) is shown. An eyeglass frame (22) has an attachment mechanism (100) to an Assembly C (50). Within the frame (22), Assembly C (50) comprises a prescription lens (60), a right plastic lens holder (24 a) that also comprises a first rotatable pin (36), wherein the right plastic lens holder (24a) holds an outer prism (32). In addition, Assembly C (50) comprises a second right plastic lens holder (24b) that holds an inner prism (34). The eyeglass frame (22) is further comprised of a first and second slot (70) and (80). More specifically, the outer lens (32) and its holder (24a) are bonded together and a hole (unnumbered and not shown) for the first pin (36) is drilled though its holder (24a) and into a base of the outer prism (32).

Summarizing, in a preferred embodiment, a prescription lens (60) is combined atop a right outer variable prism (32), wherein the right outer prism (32) is further combined atop a right inner variable prism (34). And furthermore, the right prescription lens (60), the right outer prism (32), and the right inner prism (34) are secured respectively in right lens holders (24a and 24b).

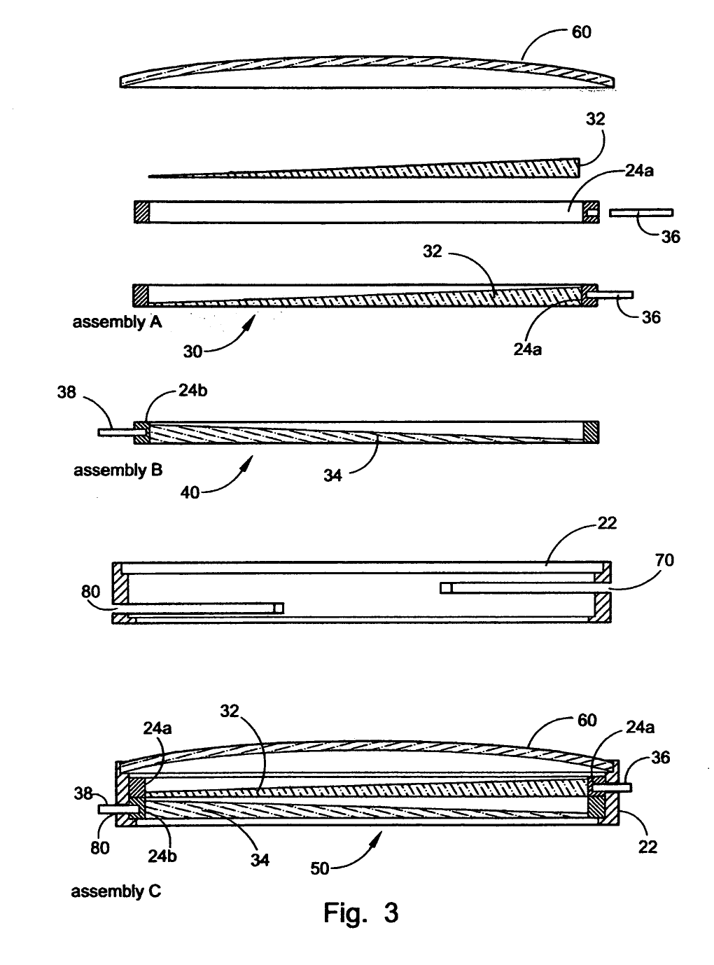

Referring next to FIG. 3, an exploded section view of a typical two prism embodiment with prescription lens of a preferred embodiment is shown of three assemblies (30), (40), (50) of the present invention. Assembly A (30) is comprised of an outer prism (32), a plastic lens holder (24a), and a first rotatable pin (36). Assembly B (40) is Assembly A (30) rotated 180 degrees. Assembly B (40) is in like fashion comprised of an inner prism (34) and a plastic lens holder (24b). Also shown in Assembly B (40) is a second rotatable pin (38). Assembly C (50) is comprised of Assembly A (30), Assembly B (40), a prescription lens (60), and an eyeglass frame (22). The eyeglass frame (22) is further comprised of a first and second slot (70) and (80). More specifically, the outer prism (32) and its holder (24a) are bonded together and a hole (unnumbered and not shown) for a first pin (36) is drilled though its holder (24a) and into a base of the outer prism (32). The first pin (36) is bonded to the base of the prism (32). Therefore, outer prism (32), lens holder (24a), and first pin (36) are one assembly A (30). This first rotatable pin (36) is used to rotate Assembly A (30) in the eyeglass frame (22) in the first slot (70) through some degree range described in subsequent figures.

In a similar way, the second rotatable pin (38) penetrates the lens holder (24b) and the inner prism (34) through a second hole (not shown and unnumbered). This second pin (38) is drilled through its holder (24b) and into a base of the inner prism (34). The second pin (38) is bonded to the base of the inner prism (34). Therefore, inner prism (34), lens holder (24b), and the second pin (38) are one Assembly B (40). This second rotatable pin (38) is used to rotate Assembly B (40) in the eyeglass frame (22) in the second slot (80) through some degree range described in subsequent figures.

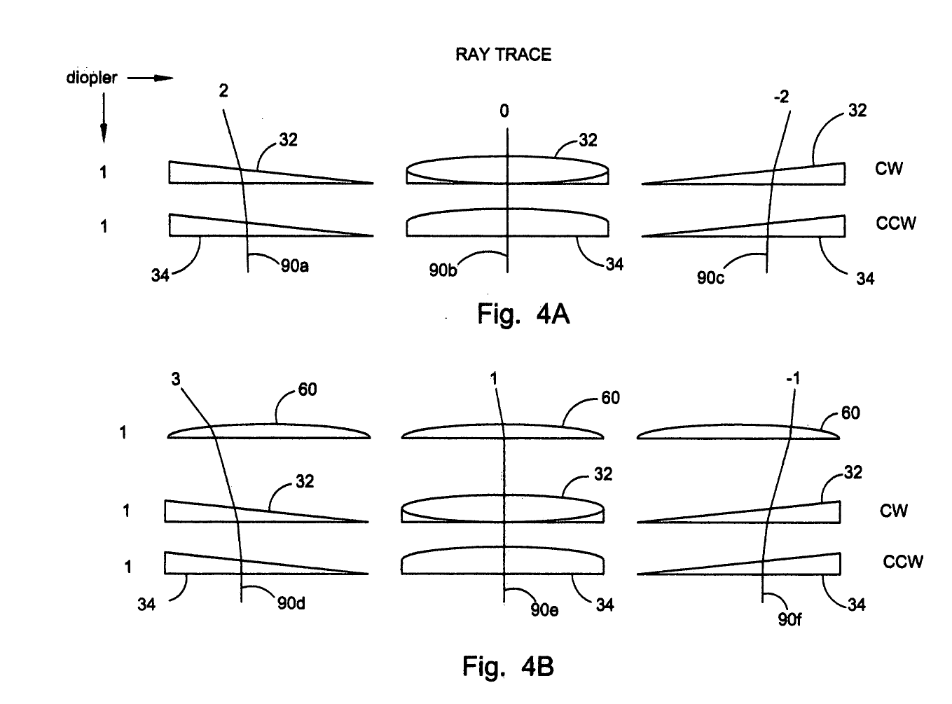

Assembly A (30) and Assembly B (40) are mounted in an Assembly C (50) with bases of Assembly A (30) and B (40) opposite each other, that is, in the optically neutral position shown in FIGS. 4a and b. The first pin (36) protrudes from Assembly C (50) through the first slot (70) and the second pin (38) protrudes through the second slot (80).

Summarizing, in the preferred embodiment, a prescription lens (60) is combined atop a right outer variable prism (32), wherein the right outer prism (32) is further combined atop a right inner variable prism (34). And furthermore, the right prescription lens (60), the right outer prism (32), and the right inner prism (34) are secured in the right lens holder (24a). Similarly, a prescription lens (60) is combined atop a left outer variable prism (32), wherein the left outer prism (32) is further combined atop a left inner variable prism (34). Furthermore, the prescription lens (60), the left outer prism (32), and the left inner prism (34) are secured in the left lens holder (24b).

Another possible embodiment is without prism holders (24a and 24b). The prisms (32 and 34) are secured directly into the eyeglass frame (22). Therefore, the first and second rotatable pins (36 and 38) are attached directly to the upper and inner prisms (32 and 34) of their respective prescription lens with two variable prisms (20a and 20b).

Dimensions of the eyeglass frame and lenses are not shown. However, the dimensions are generally similar to conventional eyeglasses. Materials may be similar to conventional eyeglasses, including plastics, various metal options, and glass.

Now referring to FIGS. 4a and 4b, a partial view of a preferred embodiment of eyeglass prisms is shown of multiple light ray traces (90a, 90b, 90c, 90d, 90e, and 901) for numerous prism diopters of multiple embodiments of the present invention. “Ray trace” is a common term used to describe how light is refracted through a lens, in this case, through two prisms. Under the condition where both eyes are only slightly and equally affected, one prism lens per eye may be used. The prism can also be physically rotated allowing the patient or doctor to coordinate the left eye with the right eye. In other words, this rotation allows adjustment of the patient's vision. However if Strabismus is at all severe, the two prism system can be used to eliminate the vertical component. This is a possible use but is not recommended.

What follows is a description of how the simultaneous rotation of each prism affects the user's center of vision. More specifically, we are speaking of the “center of vision” or how light refracts and affects the user's ability to pinpoint a specific object with both eyes at the same time.

As previously discussed, Strabismus is the inability of both eyes to simultaneously focus on one object at the same time. Specifically, the prisms are counter rotated allowing the user or doctor to realign the center of vision. Both prism pairs can be rotated, or adjusted, at the same time, thus allowing realignment of both eyes, bringing the center of vision back to a universally correct position.

Continuing with reference to FIG. 4a, the three traces (90a, 90b, and 90c) represents the movable range of the center of vision. As each prism is rotated in the opposite direction, in unison with its counterpart, the center of vision will move from one trace (90a) to another (90c). Typically, an outer prism (32) is rotated the same number of degrees as the opposite inner prism (34). Then, the user, will see two images move into one as the center of vision of one eye matches the center of vision of the other eye. This prism position then represents the common focal point, and both eyes can now view one object at the same time.

Now, FIG. 4a shows the prisms in three different configurations. Each of the three traces (90a, 90b, and 90c) in this example shows each prism in different states of rotation. The left trace (90a) is the +2 diopter prism configuration. The center trace (90b) is the neutral diopter prism configuration. And the right trace (90c) is the −2 diopter prism configuration. The center trace (90b) is shown in a neutral position, meaning no correction is made. With this center trace (90b), the invention has a dioptic range of 4.0 (plus or minus 2.0 from neutral). As each prism rotates away from neutral, towards the left trace (90a) or right trace (90c), the refraction becomes greater until it reaches its maximum corrective capability at +/−2.0 diopters. The line running through each of the three traces (90a, 90b, and 90c) in FIG. 3a illustrates line of sight.

Now referring to FIG. 4b, a typical prescription lens (60) in conjunction with the invention's rotating prisms is shown. FIG. 4b shows the prisms in three different configurations. Each of three traces (90d, 90e, and 900 in this example shows each prism in different states of rotation. The left trace (90d) is the +3 diopter prism configuration. The center trace (90e) is the +1 diopter prism configuration. And the right trace (900 is the −1 diopter prism configuration.

In this example, the patient's prescription corrects his or her vision to 1.0 diopter. A center trace (90e) shows the outer and inner prisms (32) and (34) in the neutral 0 diopter position with the prescription lens (60) shown above the two prisms (32) and (34). As the prisms (32) and (34) rotate away from neutral, towards left or right traces (90d or 90f), the amount of correction becomes greater, until it reaches its maximum corrective capability at +3.0 and −1.0 diopters. Therefore, a ray trace of the VPG will create a single adjustable focal point movable to any X/Y coordinates within the given range of the variable prisms (32) and (34).

In addition, other embodiments include variable prism eyeglasses (10) consisting of one rotating and one counter-rotating prism lens in only one eye without a prescription lens, or, alternatively, one rotating and one counter-rotating prism lens in only one eye with a prescription lens. Still other embodiments consist of a single variable prism integrated into the prescription lens in one eye, or alternatively, a variable prism integrated into the prescription lens for both eyes. The present description does not preclude other embodiments that may be envisioned within the spirit and intent of the present invention.

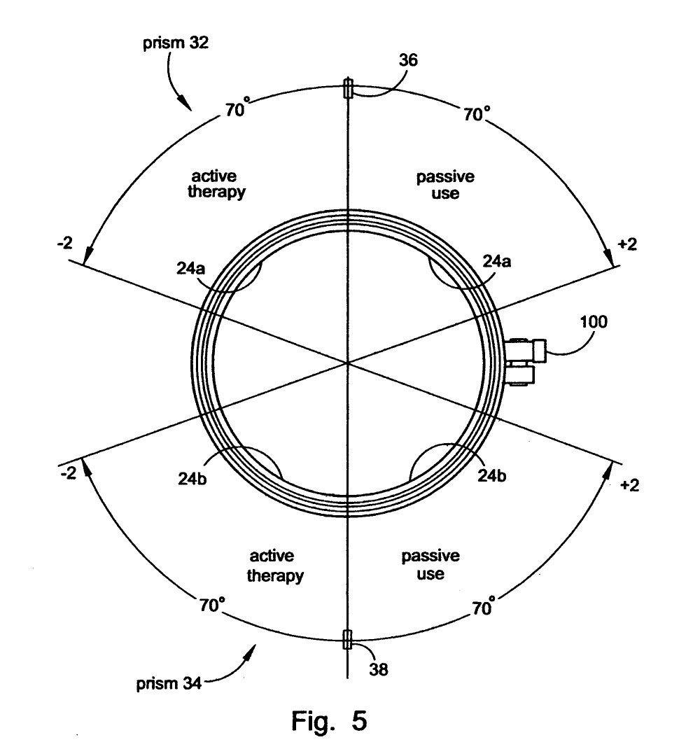

Referring next to FIG. 5, a partial view of prism holders (24a and b) is shown illustrating degree ranges for active and passive Strabismus therapy of the present invention. Also shown is the attachment mechanism (100) of the eyeglass frame (22) for reference purposes only. The invention can be used in two different ways, actively and passively, both of which correct the center of vision of the user. Variable prism eyeglasses (10) (not shown in this figure) are used to actively (therapeutically) and passively (non-therapeutically) correct double vision. Alternatively, the VPG's (10) can be used only therapeutically. Another alternative is to use the VPG's (10) passively.

Continuing with FIG. 5, active treatment, otherwise known as therapeutic treatment, operates in a specific range of rotation. The total rotational ability of each prism pair is 140 degrees. Half of this range, or 70 degrees, is dedicated to therapeutic treatment, while the second half is dedicated to passive treatment. As first and second rotatable pins (36 and 38) are moved in the direction of the arrows into the passive section, the corrective strength goes from 0 to +2 diopters. As the pins (36 and 38) are moved in the direction of the arrows into the active therapy side, the strength goes from 0 to −2 diopters. As shown in FIG. 5, the first rotatable pin (36) is associated with the upper prism (32), while the second rotatable pin (38) is associated with the inner prism (34).

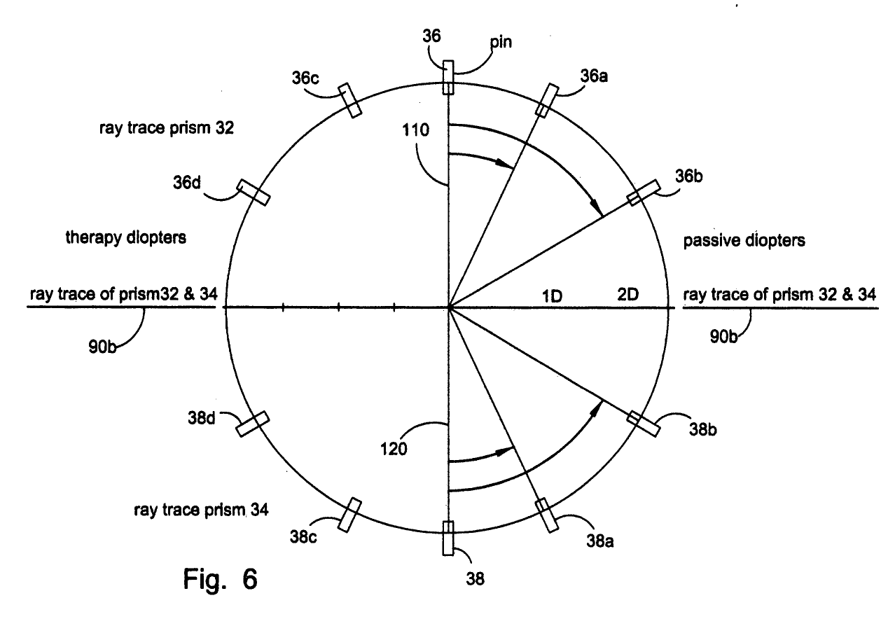

Finally, referring to FIG. 6, a partial view is shown of numerous positions of first and second rotatable pins (36 and 38) used to change the diopters of the prisms to treat Strabismus in the present invention. As shown in FIG. 6, the first rotatable pin (36) is associated with the upper prism (32), while the second rotatable pin (38) is associated with the inner prism (34). A first rotatable pin (36) is shown in a +1 diopter position (36a) and in a +2 diopter position (36b). A second rotatable pin (38) is shown in a +1 diopter position (38a) and a +2 diopter position (38b). Conversely, and to the left side of FIG. 6, the first rotatable pin (36) is shown in a −1 diopter position (36c). This rotatable pin (36) is also shown in a −2 diopter position (36d). Additionally, the second rotatable pin (38) is shown in −1 and −2 diopter positions (38c and 38d).

Comparing FIG. 5 to FIG. 6, FIG. 6 is more detailed. FIG. 6 also illustrates the invention's ability to vary the dioptic range of the patient's prescription eyeglasses. As the two prisms (32 and 34) (not shown) are rotated, one clockwise (cw), and the other counterclockwise (ccw), the positive upper portion of the ray trace (110) from an outer prism (32) is canceled out by the negative lower portion of the ray trace (120) from an inner prism (34) resulting in a neutral ray trace (90b) in the horizontal direction in this figure. Note that this description applies to passive therapy or active therapy. In FIG. 6, the passive therapy representation is the right side of the figure, while the active therapy is to the left side of the figure.

This canceling action was shown previously in FIG. 4a in the center ray trace (90b). Examples throughout this application have used prisms of +1 diopter. However, any reasonable power can be used within the limits of the designed prism characteristics.

Consequently, while the foregoing description has described the principle and operation of the present invention in accordance with the provisions of the patent statutes, it should be understood that the invention may be practiced otherwise as illustrated and described above and that various changes in the size, shape, and materials, as well as on the details of the illustrated construction may be made, within the scope of the appended claims without departing from the spirit and scope of the invention.

### GLOSSARY

10 typical eyeglasses with variable prisms installed
20a right prescription lens with two variable prisms
20b left prescription lens with two variable prisms
22 eyeglass frame
24a right lens holder
24b left lens holder
30 Assembly A
32 outer prism
34 inner prism
36 first rotatable pin
38 second rotatable pin
40 Assembly B
50 Assembly C
60 typical prescription lens
70 first slot
80 second slot
90a +2 diopter prism configuration
90b Neutral diopter prism configuration
90c −2 diopter prism configuration
90d +3 diopter prism configuration
90e +1 diopter prism configuration
90f −1 diopter prism configuration
100 attachment mechanism
110 positive upper ray trace
120 negative lower ray trace

What is claimed is:

1. An eyeglass device comprised of:
an eyeglass frame,
a left lens holder secured in said frame,
a right lens holder secured in said frame,
a left eye prescription lens combined atop a left outer variable prism, wherein said left outer prism is further combined atop a left inner variable prism, and further wherein said left prescription lens, said left outer prism, and said left inner prism are secured in said left lens holder, and
a right eye prescription lens combined atop a right outer variable prism, wherein said right outer prism is further combined atop a right inner variable prism, and further wherein said right prescription lens, said right outer prism, and said right inner prism are secured in said right lens holder, whereby said eyeglass device corrects Strabismus.

2. Variable prism eyeglasses comprised of:
an Assembly “A” comprised of multiple parts per eye, wherein said Assembly “A” is further comprised of an outer variable prism per eye, a first plastic lens holder, and a first rotatable pin, said first pin being drilled through said first plastic lens holder and bonded to a base of said outer variable prism.
an Assembly “B” comprised of multiple parts per eye, wherein said Assembly “B” is further comprised of an inner variable prism per eye, and a second rotatable pin, said second pin being drilled through said second plastic lens holder and bonded to a base of said inner variable prism, and further wherein said Assembly “B′ is rotated 180 degrees in relation to assembly “A”, and
an Assembly “C” comprised of multiple parts per eye, wherein said Assembly “C” is further comprised of Assembly “A”, Assembly “B”, a prescription lens, a plastic lens holder, and an eyeglass frame, whereby said variable prism eyeglasses correct Strabismus.

3. The eyeglass device according to claim 1, wherein said left and right eye prescription lens are combined atop one variable prism for each eye.

4. The eyeglass device according to claim 1, wherein said left outer prism is further combined atop a left inner variable prism for each eye, without a prescription lens.

5. A method of using variable prism eyeglasses wherein said method comprises the steps of:
counter rotating outer and inner variable prisms in one eye, as needed, by a user, by rotating first and second rotatable pins secured respectively in said outer and inner prisms, and further wherein said pins are secured in a plastic lens holder, said lens holder being secured in an eyeglass frame, whereby Strabismus is optically corrected, and
counter rotating outer and inner variable prisms in another eye, as needed, by a user, by rotating first and second rotatable pins secured respectively in said outer and inner prisms, and further wherein said pins are secured in a plastic lens holder, said lens holder being secured in an eyeglass frame, whereby Strabismus is optically corrected, or alternatively,
counter rotating outer and inner variable prisms in one eye, as needed, by a doctor, by rotating first and second rotatable pins, whereby Strabismus is therapeutically corrected, and
counter rotating outer and inner variable prisms in another eye, as needed, by a doctor, by rotating first and second rotatable pins, whereby Strabismus is therapeutically corrected.

6. A method of using variable prism eyeglasses, according to claim 5 wherein said method further comprises the steps of:
making minor adjustments by said user using said rotatable pins during a day as needed when eye fatigue occurs, rotating said outer prism the same number of degrees in an opposite direction, in unison with its counterpart, said inner prism, whereby said user sees two images move into one as the center of vision of one eye matches the center of vision of the other eye, and further whereby said two images now represent a common focal point.

7. A method of using variable prism eyeglasses, according to claim 5 wherein said method further comprises the step of:
gradual strengthening of one or more eye muscles, whereby a doctor is counter rotating outer and inner variable prisms in one eye, as needed, by rotating first and second rotatable pins, whereby Strabismus is therapeutically corrected, and, whereby a doctor is counter rotating outer and inner variable prisms in another eye, as needed, by a doctor, by rotating first and second rotatable pins, whereby Strabismus is therapeutically corrected.

8. (canceled)
